(19) United States
(12) Patent Application Publication
(10) Pub. No.: US 2010/0193337 A1
(43) Pub. Date: Aug. 5, 2010

(54) SYSTEMS AND METHODS FOR CONTROLLING OPERATION OF ELECTRONIC DEVICES

(75) Inventors: Gene Fein, Lenox, MA (US); Edward Merritt, Lenox, MA (US)

Correspondence Address: Stolowitz Ford Cowger LLP, 621 SW Morrison St, Suite 600, Portland, OR, 97205, US

(73) Assignee: Solita Software LLC, Las Vegas, NV (US)

(21) Appl. No.: 12/756,044

(22) Filed: Apr. 7, 2010

Related U.S. Application Data
(62) Division of application No. 11/345,646, filed on Jan. 31, 2006.
(60) Provisional application No. 60/651,770, filed on Feb. 10, 2005.
(60) Provisional application No. 60/649,064, filed on Jan. 31, 2005.

(51) Int. Cl. G04F 1/00; H01R 13/70

(52) U.S. Cl. 200/33 R; 200/51 R

(57) ABSTRACT

Disclosed is an apparatus and method for controlling operation of electronic devices. A power interrupt type device may facilitate controlling operation of the electronic device. Additionally, a controllable security device may be communicatively coupled to the power interrupt type device.

### RELATED APPLICATIONS AND CROSS REFERENCES

The subject matter disclosed herein claims priority to U.S. Ser. No. 60/649,064, titled, TIMER CONTROL SYSTEM FOR LIMITING ACCESS TO ELECTRONIC DEVICES, having a filing date of Jan. 31, 2005 and to U.S. Ser. No. 60/651,770, tilted, LOCKING SYSTEMS AND METHODS FOR PREVENTING ACCESS TO ELECTRONIC DEVICES, having a filing date of Feb. 10, 2005.

### BACKGROUND

1. Technical Field

The subject matter disclosed herein relates to control of operation of electronic devices.

2. Information

Typically, control over the use of electronic devices may involve use of a password controlled setting, removal of controls, disconnection of power source, removal of power plugs, or removal of companion apparatus.

For example, control over the use of a device, such as a portable gaming device, may involve confiscation of the device, confiscating of a gaming cartridge for the device, or unplugging of the device from its power source.

### BRIEF DESCRIPTION OF THE DRAWINGS

Embodiments are illustrated by way of example and not by way of limitation in the figures of the accompanying drawings, in which like references may indicate similar elements and in which:

FIG. 1 illustrates a perspective exploded view of an embodiment of an electronic device having a power interrupt type device;

FIG. 2 illustrates an assembly of electronic device having power interrupt type device and controllable security device in accordance with another embodiment;

FIG. 3 illustrates controlling operation of electronic devices in accordance with another embodiment;

FIG. 4 illustrates controlling operation of electronic devices in accordance with another embodiment;

FIG. 5 illustrates controlling operation of electronic devices in accordance with another embodiment; and

FIG. 6 illustrates controlling operation of electronic devices in accordance with another embodiment.

### DETAILED DESCRIPTION

In the following description, embodiments will be disclosed. For purposes of explanation, specific numbers, materials, and/or configurations are set forth in order to provide a thorough understanding of the embodiments. However, it will also be apparent to one skilled in the art that the embodiments may be practiced without one or more of the specific details, or with other approaches, materials, components, etc. In other instances, well-known structures, materials, and/or operations are not shown and/or described in detail to avoid obscuring the embodiments. Accordingly, in some instances, features are omitted and/or simplified in order to not obscure the disclosed embodiments. Furthermore, it is understood that the embodiments shown in the figures are illustrative representations and are not necessarily drawn to scale.

References throughout this specification to “one embodiment” or “an embodiment” means that a particular feature, structure, material, and/or characteristic described in connection with the embodiment is included in at least one embodiment. Thus, the appearances of the phrases “in one embodiment” and/or “in an embodiment” in various places throughout this specification are not necessarily all referring to the same embodiment. Furthermore, the particular features, structures, materials, and/or characteristics may be combined in any suitable manner in one or more embodiments.

For the purposes of the subject matter disclosed herein, electronic devices may include a wide range of electronic devices such as, but not limited to, portable gaming devices, gaming consoles, audio/visual devices such as televisions and stereos, household appliances, and so forth. However, for the purposes of describing the subject matter, references may be made to portable gaming devices and/or gaming consoles, such as those available from Nintendo of America, Inc., of Redmond, Wash., and the subject matter is not limited to a type of electronic device. Additionally, for the purposes of the subject matter disclosed herein, power may include a wide range of electronic signals including, but not limited to, wireless radio based type signals, and accordingly, the claimed subject matter is not limited in these respects.

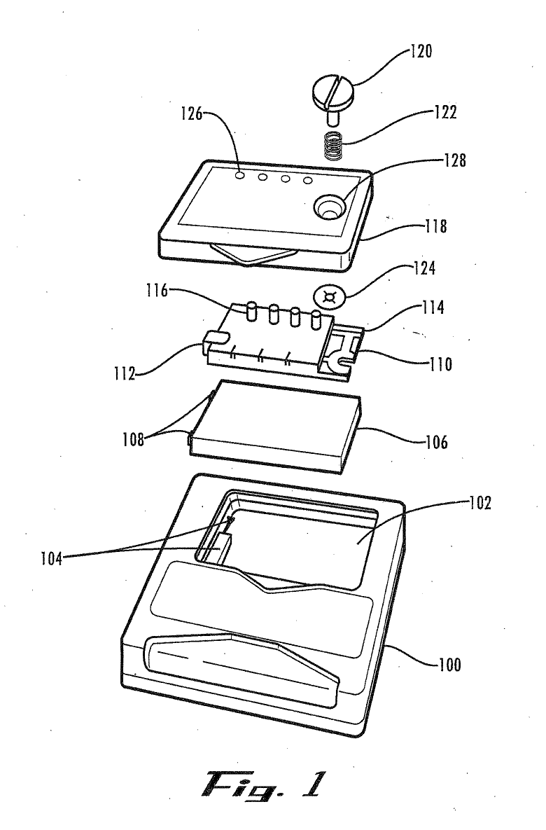

Turning now to the figures, FIG. 1 illustrates a perspective exploded view of an embodiment of an electronic device having a power interrupt type device. Illustrated in FIG. 1, electronic device 100 may include a compartment 102 having one or more electrical contacts (hereon-out, compartment contacts) 104. Compartment 102 may facilitate to accommodate a power source 106, where power source 106 may also have one or more electrical contacts (hereon-out, power source contacts) 108. Additionally, in accordance with an embodiment, electronic device 100 may include a power interrupt type device 110.

In the embodiment illustrated in FIG. 1, power interrupt type device 110 may comprise of a contact (hereon-out, a jumper type contact) 112, conductive tracings 114, and visual indicators 116. Power interrupt type device 110 may be communicatively coupled to a controllable security device 118. As shown, controllable security device 118 may comprise of a screw-in slot type mechanism 120, a spring 122, contact disk 124, a number of openings 126, and a keyhole 128.

As will be described in further detail, in various embodiments, power interrupt type device 110 and controllable security device 128 communicatively coupled to the power interrupt type device 110 facilitates control over the use of electronic devices. It should be appreciated that communicatively coupled may include a wide variety of communicatively coupling such as, but not limited to, electrical type communicatively coupling and/or mechanical type communicatively coupling and may refer to any type of interaction.

Continuing to refer to FIG. 1, power source 106 may be appropriately situated within compartment 102 (i.e., compartment contacts 104 being electrically communicatively coupled to power source contacts 108). Power interrupt type device 110 may be disposed on the power source 106, and in particular, jumper type contact 112 may be disposed between at least one of the compartment contacts 104 and at least one of the power source contacts 108. Contact disk 124 may be disposed on the conductive tracings 114. Additionally, controllable security device 118 may be disposed on the power interrupt type device 110 having openings 126 aligned with visual indicators 116 and keyhole 128 substantially aligned with contact disk 124. Further, spring 122 may be disposed substantially within the keyhole 128, and screw-in slot type mechanism 120 may be disposed substantially along the spring into the keyhole 128.

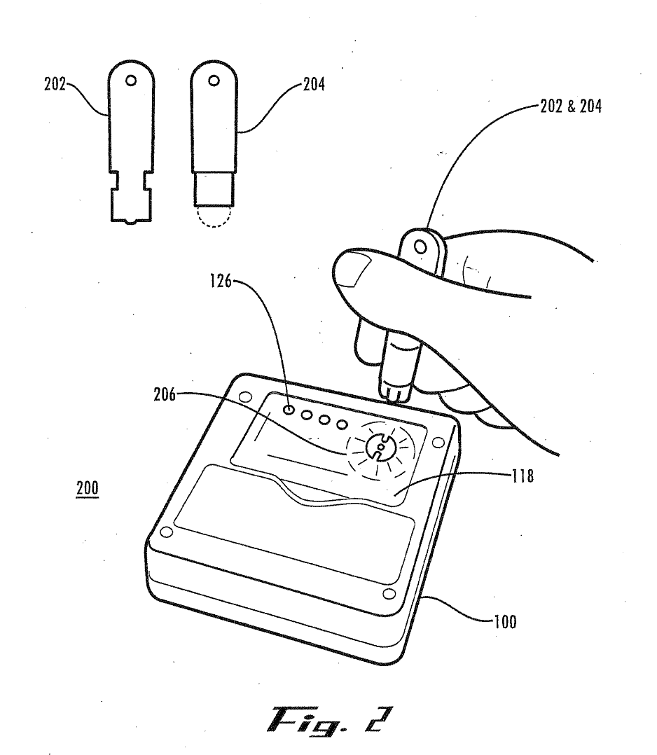

Briefly turning to FIG. 2, assembly 200 illustrates electronic device 100 having power interrupt type device 110 and controllable security device 118 in accordance with another embodiment.

Turning now back to FIG. 1, when power source 106 is appropriately situated within compartment 102 (i.e., compartment contacts 104 being electrically communicatively coupled to power source contacts 108), electronic device 100 may utilize power from power source 106. However, in accordance with an embodiment, power interrupt type device 110 may be disposed on the power source 106, and in particular, jumper type contact 112 may be disposed between at least one of the compartment contacts 104 and at least one of the power source contacts 108. Accordingly, when power interrupt type device 110 is activated, jumper type contact 112 may facilitate prevention of flow of electricity from the power source 106 to the electronic device 100, thereby preventing the electronic device 100 from operating.

An example of operation may be illustrated by referring to both FIGS. 1 and 2. In FIG. 2, controllable security device 118 (shown in FIG. 1) may have one or more of indicators 206 in accordance with another embodiment. Indicators 206 may facilitate indication of time settings. That is, indicators 206 may denote length of time before the power interrupt type device 110 is activated to prevent the electronic device 100 from operating. Additionally, in FIG. 2, a key type device 202 and 204 may be utilized to control the controllable security device 118. Accordingly, as illustrated in FIG. 2, key type device 202 and 204 may be utilized as shown to turn screw-in slot mechanism 120 to an indicator 116 corresponding to a length of time before activation of the power interrupt type device 110, which in turn, may turn disk 124 (shown in FIG. 1) that may facilitate contacts (not shown) on conductive tracings 114 to facilitate electronic control of power interrupt type device 110. Further, visual indicators 126 may facilitate to visually indicate the corresponding length of time, and accordingly, the visual indicators 126 may comprise of different color indicators to denote length of time remaining before power interrupt type device 110 activates, such as, but not limited to, red, green, blue, etc.

In FIG. 2, key 202 and 204 may comprise of a spring loaded mechanical key that may be retracted having a variety of shapes and sizes as illustrated. However, it should be appreciated that control of the power interrupt type device 110 may be facilitated by a wide variety of methods such as, but not limited to, wireless methods.

In one embodiment, power interrupt type device 110 may include electronic circuitry to operate as a wireless controllable security device. In an alternate embodiment, power interrupt type device 110 may include a transmitter/receiver (TX/RX) component to facilitate transmitting and receiving of wireless communication such as, but not limited to, data from a remote source to facilitate operation of timing functions of power interrupt device via such wireless communication methods that may employ WIFI type protocols including wireless controller type devices. In another embodiment, power interrupt type device may include an infrared (IRDA) TX/RX component to facilitate transmitting and receiving of wireless communication such as, but not limited to, data from a remote source to facilitate operation of timing functions of power interrupt device. In yet another embodiment, power interrupt device may include a global positioning system (GPS) component to facilitate determination of location of the electronic device. Further in an alternative embodiment, power interrupt device may include a TX/RX component to facilitate radio frequency type identification (RFID) to facilitate identification of the electronic device and/or user of the electronic device. In yet in a further embodiment, power interrupt type device may include a TX/RX component to facilitate transmitting and receiving of wireless communication such as, but not limited to, data from a remote source that may include a cellular phone employing a wide variety of communication protocols.

As previously described, even though in the embodiment illustrated in FIGS. 1 and 2 may comprise of a handheld gaming type electronic device, it should be appreciated that electronic device may be a wide variety electronic devices such as, but not limited to, gaming consoles, audio visual electronic devices, household appliances, etc., and accordingly, the claimed subject matter is not limited in these respects.

Power interrupt type device 110 may be a wide variety of power interrupt type devices such as, but not limited to, electronic power timers, mechanical power timers, etc., and accordingly, the claimed subject matter is not limited in these respects.

Visual indicators 116 may be a wide variety of visual indicators such as, but not limited to, light emitting diode (LED) type light source, incandescent type light source, etc., and accordingly, the claimed subject matter is not limited in these respects.

FIG. 3 illustrates controlling operation of electronic devices in accordance with another embodiment. In FIG. 3, an audio/visual electronic device 300 may be coupled to an electronic device 302. Additionally, electronic device 302 may include a power interrupt type device 304 in accordance with one embodiment. In the illustrated embodiment, audio/visual electronic device 300 may comprise of a display device such as, but not limited to, a television/monitor, and electronic device 302 may comprise of any type of electronic device that may provide a signal to an audio/visual electronic device such as, but not limited to, a gaming console type device. As previously alluded to, power interrupt device 304 may be communicatively coupled to a controllable security device (not show) that may facilitate interruption of power to the electronic device 302 based in part on security devices such as, but not limited to, a key, a password, a code from a remote source that may include a wireless remote source. The power interrupt device may be provided as an after-market device or alternatively may be provided as part of the original device.

In accordance with various embodiments, an electronic device control system may further facilitate locking of the use of the electronic devices. In one embodiment, upon expiration of an allocated time period, access to the electronic device may be denied until the control system is reset through the use a control system key and/or password.

In one embodiment of the present invention, the locking control system may include a timing apparatus, such a those available commercially, for proscribing, for instance, specific amounts of time, no time or unlimited time during which the electronic device may be used. The control system may also employ a lock, password, switch or key to allow operation of the control system by persons in possession of the key and/or valid password to the system. In addition, the timing apparatus may be for proscribing a time limit when access to the control system is made. In an embodiment, the password may be preset by the manufacturer, or may be generated by the owner or controller of the control system. In addition, the password or key may be changeable. The control system, as indicated, may include a locking device to prevent circumventing the system.

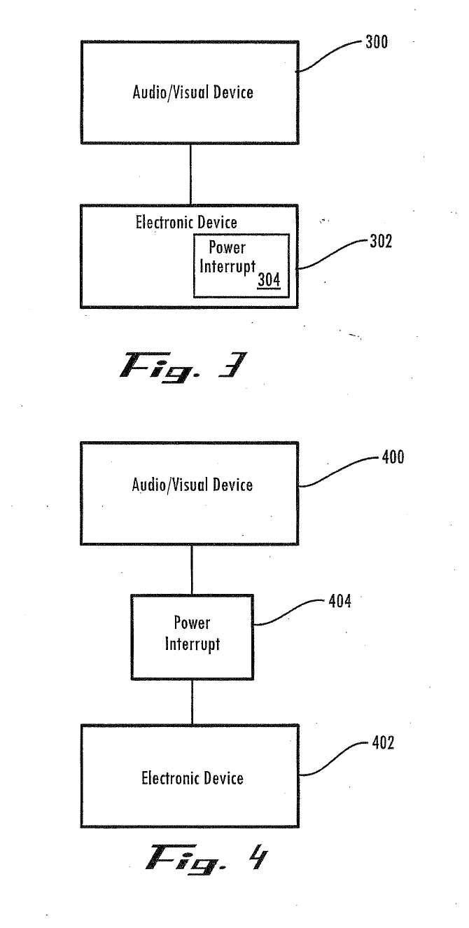

FIG. 4 illustrates controlling operation of electronic devices in accordance with another embodiment. In FIG. 4, an audio/visual electronic device 400 may be coupled to an electronic device 402. Additionally, a power interrupt type device 404 may be coupled between the electronic device 402 in accordance with one embodiment. In the illustrated embodiment, audio/visual electronic device 400 may comprise of a display device such as, but not limited to, a television/monitor, and electronic device 402 may comprise of any type of electronic device that may provide a signal to an audio/visual electronic device such as, but not limited to, a gaming console type device. As previously alluded to, power interrupt device 404 may be communicatively coupled to a controllable security device (not show) that may facilitate interruption of power between the audio/visual electronic device 400 and the electronic device 402 based in part on security devices such as, but not limited to, a key, a password, a code from a remote source that may include a wireless remote source. Here again, the power interrupt device 404 may be provided as an after-market device or alternatively may be provided as part of the original device.

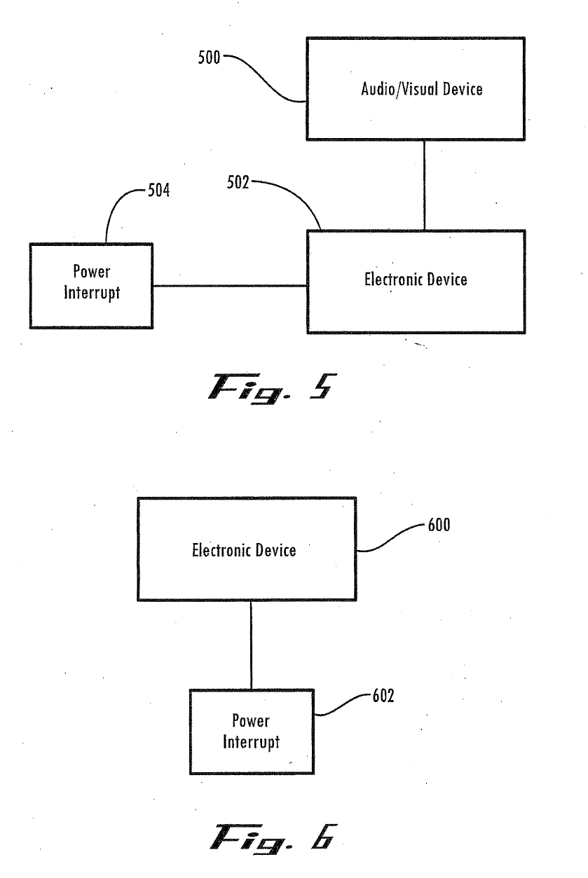

FIG. 5 illustrates controlling operation of electronic devices in accordance with another embodiment. In FIG. 5, an audio/visual electronic device 500 may be coupled to an electronic device 502. A power interrupt type device 504 may be coupled to electronic device 402 in accordance with one embodiment. In the illustrated embodiment, audio/visual electronic device 500 may comprise of a display device such as, but not limited to, a television/monitor, and electronic device 502 may comprise of any type of electronic device that may provide a signal to an audio/visual electronic device such as, but not limited to, a gaming console type device. As previously alluded to, power interrupt device 504 may be communicatively coupled to a controllable security device (not show) that may facilitate interruption of power between the audio/visual electronic device 500 and the electronic device 502 based in part on security devices such as, but not limited to, a key, a password, a code from a remote source that may include a wireless remote source. Here again, the power interrupt device 504 may be provided as an after-market device or alternatively may be provided as part of the original device.

FIG. 6 illustrates controlling operation of electronic devices in accordance with another embodiment. In FIG. 6, an electronic device 600 may be coupled to power interrupt type device 602 in accordance with one embodiment. In the illustrated embodiment, electronic device 600 may comprise of a household appliance type electronic device such as, but not limited to, a hair dryer. As previously alluded to, power interrupt device 602 may be communicatively coupled to a controllable security device (not show) that may facilitate interruption of power to the electronic device 600 based in part on security device such as, but not limited to, a key, a password, a code from a remote source that may include a wireless remote source. Here again, the power interrupt device 602 may be provided as an after-market device or alternatively may be provided as part of the original device. Further in the illustrated embodiment of FIG. 6, power interrupt device 602 may be disposed to interrupt power to the electronic device 600 along its power cord, or alternatively, at its plug (i.e., at the power outlet).

In an embodiment, if the power is interrupted via a On/Off switch on an electronic device, the power interrupt device, in particular the timer, may continue to run and facilitate saving of any remaining time for future use.

While there has been illustrated and/or described what are presently considered to be example embodiments of claimed subject matter, it will be understood by those skilled in the art that various other modifications may be made, and/or equivalents may be substituted, without departing from the true scope of claimed subject matter. Additionally, many modifications may be made to adapt a particular situation to the teachings of claimed subject matter without departing from subject matter that is claimed. Therefore, it is intended that the patent not be limited to the particular embodiments disclosed, but that it covers all embodiments falling within the scope of the appended claims.

1-17. (canceled)

18. An apparatus, comprising:
an electrical connector configured to mate with a power connector;
a conductive structure positioned between the electrical connector and the power connector, the conductive structure configured to receive electricity transferred between the connectors; and
an interrupt device configured to selectively control disruption of the transfer of electricity between the connectors using the conductive structure.

19. The apparatus of claim 18, further comprising:
a screw-in mechanism positioned in an opening of the interrupt device; and
a plurality of conductive tracings distributed beneath the opening;
wherein the plurality of conductive tracings are arranged so that a first one of the conductive tracings makes contact with the screw-in mechanism if the screw-in mechanism is at a first orientation and a second different one of the conductive tracings makes contact with the screw-in mechanism if the screw-in mechanism is at a second different orientation.

20. The apparatus of claim 19, further comprising:
a depression located on a top surface of the screw-in mechanism and configured to mate with an engaging region of a key to allow only the key to turn the screw-in mechanism thereby regulating control over the orientation of the screw-in mechanism.

21. The apparatus of claim 20, wherein the interrupt device is configured to allow a first amount of time to pass before preventing electrical flow in response to the screw-in mechanism making contact with the first tracing, and wherein the interrupt device is configured to allow a second different amount of time to pass before preventing electrical flow in response to the screw-in mechanism making contact with the second tracing.

22. The apparatus of claim 19, wherein the screw-in type mechanism includes a shaft extending into the opening of the interrupt device and a disk located at an end of the shaft.

23. The apparatus of claim 18, further comprising:
a housing defining a cavity for a battery;
wherein the electrical connector is located in the cavity and configured to mate with a battery terminal.

24. The apparatus of claim 18, further comprising:
a controller configured to:
determine when the conductive structure stops receiving power; and
if the conductive structure stops receiving power prior to a scheduled disruption of electrical transfer between the connectors, determine an amount of time remaining from a time that the conductive structure stops receiving power to a time of the scheduled disruption.

25. The apparatus of claim 24, wherein the controller is further configured to save an indication of the remaining time.

26. An apparatus, comprising:
means for regulating control over an orientation of an interface mechanism;
means for selectively connecting one of a plurality of first conductive regions to a second conductive region according to a current orientation of the interface mechanism; and
means for disrupting a flow of electricity between electrical connectors after a period of time that is selected according to which one of the first conductive regions is selectively connected to the second conductive region.

27. The apparatus of claim 26, further comprising:
means for housing the regulation means, the selection means, and the disruption means; and
means for locking the housing means to an exposed surface of a battery operating in a battery compartment of a portable gaming system.

28. The apparatus of claim 26, further comprising means for visually indicating the selected period of time.

29. The apparatus of claim 28, further comprising:
means for visually indicating a length of time currently remaining before a next scheduled disruption of the electrical flow.

30. The apparatus of claim 26, further comprising:
means for detecting when the disrupting means stops receiving the electrical flow; and
means for determining an amount of time remaining before a currently scheduled disruption in response to detecting the stop of the electrical flow.

31. The apparatus of claim 30, further comprising:
means for saving information related to the determined amount of time.

32. A method, comprising:
positioning a jumper proximate to a first electrical connector that receives electrical signals from a second electrical connector;
keying the surface of an interface device to regulate rotation of the interface device according to possession of a corresponding key tool; and
configuring a control device to prevent a flow of electricity between the connectors using the jumper device according to a current orientation of the interface device.

33. The method of claim 32, further comprising:
locking a position of a chassis containing the jumper relative to an exposed surface of a battery of an electronic device.

34. The method of claim 32, further comprising:
configuring a housing containing the jumper and to lock together with a video signal interface; and
positioning the jumper between video connections to enable the control device to disrupt transmission of video information from a gaming console to a display.

35. The method of claim 32, further comprising:
positioning the jumper proximate to a power supply wire extending to a display device of a portable gaming device;
wherein the control device is configured to prevent the display device of the portable gaming device from receiving power independently of whether another component of the portable gaming device continues to receive power.

36. The method of claim 32, further comprising:
configuring a wireless transmitter to send a signal selected according to the current orientation of the interface device to remotely control disruption of the electrical flow between the connectors.

37. The method of claim 32, further comprising:
configuring the control device to determine a Radio Frequency IDentification (RFID) of an electronic device that corresponds to one or both of the electrical connectors.

38. The method of claim 32, further comprising positioning a conductive tab between the first and second electrical connectors.
